(19) United States
(12) Patent Application Publication
(10) Pub. No.: US 2026/0337441 A1
(43) Pub. Date: Oct. 29, 2026

(54) POLYMERIC SCHIFF BASE WITH KETONIC RESINS

(71) Applicant: The Boeing Company, Arlington, VA (US)

(72) Inventors: Waynie M. SCHUETTE, Troy, IL (US); Andrew M. ZWEIG, Akron, OH (US); Priyanka G. DHIRDE, Navi Mumbai (IN)

(73) Assignee: The Boeing Company, Arlington, VA (US)

(21) Appl. No.: 19/114,691

(22) PCT Filed: Aug. 11, 2023
(86) PCT No.: PCT/US2023/072059

§ 371 Date: Mar. 24, 2025

Related U.S. Application Data
(60) Provisional application No. 63/452,322, filed on Mar. 15, 2023.

(30) Foreign Application Priority Data
Oct. 14, 2022 (IN) 202211058873

(51) Int. Cl. C09D 161/34; C08G 14/14

(52) U.S. Cl. CPC C09D 161/34; C08G 14/14

(57) ABSTRACT

In some aspects, a polymer is represented by Formula (VII): wherein: each of R⁵ and R⁸ is independently hydrogen or —CH₂OH; each of R⁶, R⁷, R^{6′}, R^{7′}, R^{5′}, R^{5″}, R^{8′}, and R^{8″} is independently a bond, aryl, alkyl, cycloalkyl, or heteroaryl, wherein R⁶ and R⁷, R^{6′} and RT, R^{5′} and R^{5″}, and R^{8′} and R^{8″} independently may combine to form a cycloalkyl ring or an aryl ring; each of Q^{1″} and Q^{1′″} is independently oxygen, sulfur, or each of R⁹, R¹⁰, and R¹¹ independently hydrogen, amino, aryl, alkyl, cycloalkyl, or heteroaryl; each of Q¹ and Q^{1′} is independently oxygen or sulfur; x is a positive integer, z is 0 or a positive integer, x+z is such that the polymer represented by Formula (VII) has a molecular weight of about 400 g/mol to about 20,000 g/mol.

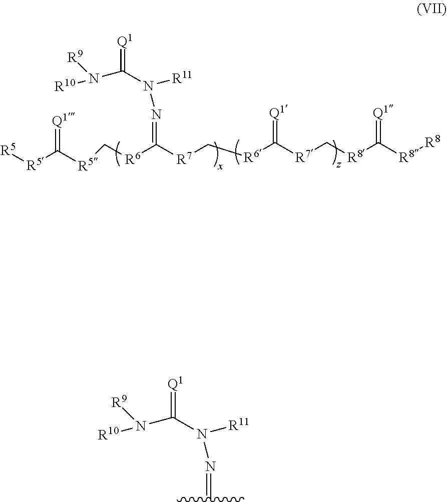

### RELATED APPLICATIONS

This application claims benefit of and priority to U.S. Application No. 63/452,322, filed Mar. 15, 2023, and Indian Patent Application number 202211058873, filed Oct. 14, 2022, the entire contents of which are incorporated herein by reference.

### GOVERNMENT SUPPORT

This invention was made with Government support under (W912HQ-21-C-0067) awarded by (Department of Defense). The government has certain rights in this invention.

### FIELD

Aspects of the present disclosure relate to Schiff base polymers and methods of making the same.

### BACKGROUND

Polymers can be used to prevent corrosion of a metal surfaces, such as steel. Such polymeric materials can be applied as a coating to act as a barrier between the substrate and outside corrosive environments. However, simply applying a coating does not necessarily result in long-term corrosion protection, as multiple different variables (e.g. coating adhesive properties and hydrophobic/hydrophilic properties) can dictate the rate and to what degree corrosion of the metal substrate can progress. Additionally, some coating systems have received concerns regarding their potential environmental impact, such as toxic chemical compositions, product lifetimes, and volatile organic content (VOC) requirements.

In some instances, these and other potential issues can be combated via inclusion of reinforcing additives, platelets, and particles. Not only does the addition of such materials increase the overall physical performance of polymers, but they also increase the overall amount of chemical components involved to produce an adequate coating. Additionally, including such additives into a coating composition can increase the tortuosity of the final coating, thereby increasing the coating's ability to resist the ingression of the surrounding acidic environment to the substrate. However, the addition of such materials can cause adverse effects to their intended application, such as brittleness and increased cost.

Thus, there is a need for improved corrosion protection materials and processes.

### SUMMARY

In some aspects, a polymer is represented by Formula (VII):

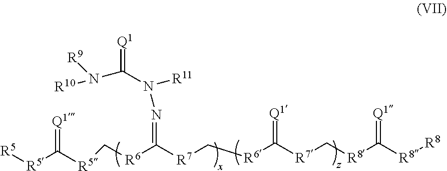

wherein:
each of R⁵ and R⁸ is independently hydrogen or —CH₂OH;
each of R⁶, R⁷, R^{6′}, R^{7′}, R^{5′}, R^{5″}, R^{8′}, and R^{8″} is independently a bond, aryl, alkyl, cycloalkyl, or heteroaryl, wherein R⁶ and R⁷, R^{6′} and R^{7′}, R^{5′} and R^{5″}, and R^{8′} and R^{8″} independently may combine to form a cycloalkyl ring or an aryl ring;
each of Q^{1″} and Q^{1′″} is independently oxygen, sulfur, or

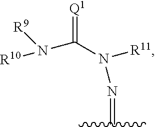

each of R⁹, R¹⁰, and R¹¹ is independently hydrogen, amino, aryl, alkyl, cycloalkyl, or heteroaryl;
each of Q¹ and Q^{1′} is independently oxygen or sulfur;
x is a positive integer, z is 0 or a positive integer, x+z is such that the polymer represented by Formula (VII) has a molecular weight of about 400 g/mol to about 20,000 g/mol, and the polymer represented by Formula (VII) is a block copolymer or a random copolymer.

In some aspects, a method of forming a polymer includes introducing formaldehyde with a ketone to form an intermediate polymer followed by treating the intermediate polymer with a carbazide/semicarbazide represented by the formula:

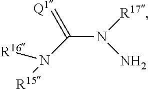

wherein Q^{1″} is oxygen or sulfur, and each of R^{15′}, R^{16′} and R^{17′} is independently hydrogen, amino, aryl, alkyl, cycloalkyl, or heteroaryl.

In some aspects, a polymer is represented by Formula (XXV):

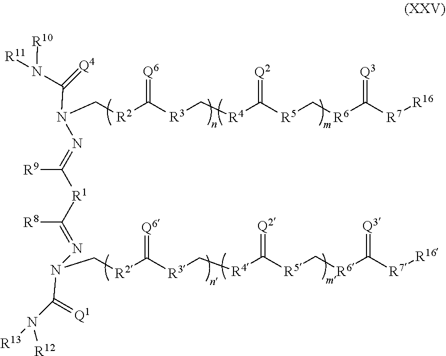

wherein:
R¹ is aryl, alkyl, cycloalkyl, or heteroaryl;
each R¹⁰ and R¹² is independently hydrogen, alkyl, cycloalkyl, aryl, or heteroaryl;
each of R⁸ and R⁹ is independently hydrogen, alkyl, cycloalkyl, aryl, or heteroaryl;
each of R¹¹ and R¹³ is independently hydrogen or represented by the formula:

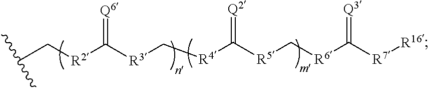

each instance of R², R³, R⁴, R⁵, R⁶, R⁷, R^{2′}, R^{3′}, R^{4′}, R^{5′}, R^{6′}, R^{7′} is independently aryl, alkyl, cycloalkyl, or heteroaryl, wherein R² and R³, R⁴ and R⁵, R⁶ and R⁷, R^{2′} and R^{3′}, R^{4′} and R^{5′}, and R^{6′} and R^{7′} independently may combine to form a cycloalkyl ring or an aryl ring;
each instance of R¹⁶ and R^{16′} is independently hydrogen or —CH₂OH;
each instance of Q¹, Q², Q^{2′}, and Q⁴ is independently oxygen or sulfur;
each instance of Q³, Q^{3′}, Q⁶, and Q^{6′} is independently oxygen, sulfur, or

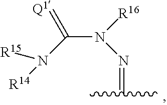

wherein each instance of Q^{1′} is independently oxygen or sulfur, and each instance of R¹⁴, R¹⁵ and R¹⁶ is independently hydrogen, aryl, alkyl, cycloalkyl, or heteroaryl,
each instance of n and n′ is independently a positive integer;
each instance of m and m′ is independently 0 or a positive integer, and the polymer represented by Formula (XXV) is a block copolymer or a random copolymer.

### DETAILED DESCRIPTION

Recent advancements in materials and polymer science has shown that implementing certain chemical additives, able to interact with potential sites of corrosion, provide promising results in inhibiting corrosion without the need for reinforcing additives, platelets, and particles. As such, Schiff base organic compounds are widely regarded as excellent corrosion inhibitors for metal substrates, such as mild steel. Without being bound by theory, these inhibitors operate via an adsorption mechanism of the metal surface, thereby blocking potential sites of corrosion.

In some instances, it may be advantageous to chemically tether a Schiff base organic compound onto a polymer used in a coating composition, to eliminate the use of additive materials. While there have been attempts to do so, many prior Schiff base polymers are low molecular weight, linear, and contain functional groups typically as part of the backbone, all of which limits accessibility of the polymer to a metal surface that has significant contours.

Thus, there is a need to develop new Schiff base polymers and methods of forming the same, for corrosion inhibition of metal surfaces, such that the polymers have high molecular weight, are optionally linear, and that have pendant functional groups.

Aspects of the present disclosure relate to Schiff base polymers and methods of making the same. It has been discovered that ketonic resins can be functionalized to form Schiff bases providing pendant functional groups to provide high molecular weight polymers. The functional groups can be spaced apart from one another, which is advantageous because polar functional groups close together tend to associate with other polar functional groups which promotes aggregation of the polymers, reducing metal surface coverage. Spaced out functional groups retain access to a metal surface and also reduce the cost of the overall polymer because advantageous functional groups are utilized more efficiently. Use of high molecular weight polymers (i.e., such as about 400 g/mol to about 20,000 g/mol) also provides faster viscosity build as solvent evaporates during application of the polymer to a metal substrate, which reduces sag or drip of the polymer layer disposed on the metal substrate.

### Post-Polymerization Modification to Achieve Schiff Base Polymers

In general, a post-polymerization modification provides certain advantages to the production of polymeric material, such as, but not limited to, the ability to formulate polymers comprised of sensitive monomers, the ability to attach identifying tags or tracers to polymers, and the ability to develop new polymers having different architectures and chemical compositions.

A polymer for undergoing post-polymerization modification can include any one or more reactive functional groups along the polymer backbone, the reactive functional groups. The polymer to undergo post-polymerization modification includes functional groups along the polymer backbone of one or more of a ketone, an aldehyde, or combinations thereof.

A polymeric Schiff base is synthesized via post-polymerization modification. In such instances, at least one ketone containing polymer is brought into contact with one or more thiosemicarbazide molecules, while being in the presence of a catalytic amount of an acid catalyst, to form a polymer having one or more Schiff base moieties.

In some aspects, the ketonic polymer to undergo post-polymerization modification is represented by Formula (I):

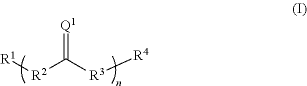

wherein;
each R₁ and R⁴ is independently aryl, alkyl, cycloalkyl, or heteroaryl;
each R² and R³ is independently aryl, alkyl, cycloalkyl, heteroaryl, a bond, or may be combined to form a cycloalkyl or aryl ring;
Q¹ is oxygen or sulfur; and
n is a positive integer of greater than 1 to about 30.

n of Formula (I) can be a positive integer greater than 1, such as about 1.1 to about 30, such as about 5 to about 30, such as about 10 to about 30, such as about 15 to about 30, such as about 20.

R² and R³ of Formula (I) can be combined to form a cycloalkyl ring or an aryl ring.

R² of Formula (I) can be a bond and R³ of Formula (I) can be selected from any one or more of

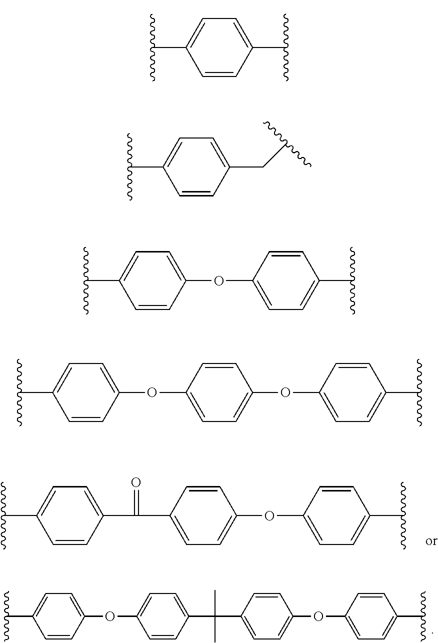

The ketonic polymer of Formula (I) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by gel permeation chromatography (GPC). In one or more aspects, the ketonic polymer of Formula (I) can have a PDI of about 1.01 to about 5.0, such as about 1.1 to about 4, such as about 1.5 to about 3.5, such as about 2 to about 3, as determined by GPC.

The ketonic polymer of Formula (I) can have a glass transition temperature (Tg) of about 50° C. to about 200° C., such as about 55° C. to about 100° C., such as about 60° C. to about 100° C., such as about 65° C. to about 80° C., as determined by differential scanning calorimetry (DSC).

In some aspects, the ketonic polymer to undergo post-polymerization modification is represented by Formula (II):

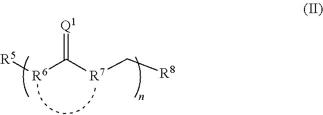

wherein,
each R⁵, R⁶, R⁷, and R⁸ is independently aryl, alkyl, cycloalkyl, heteroaryl, or may be combined to form a cycloalkyl or aryl ring, wherein R⁶ and R⁷ can be combined to form a cycloalkyl ring or an aryl ring;
Q¹ is oxygen or sulfur; and
n is a positive integer of greater than 1 to about 30.

n of Formula (II) can be a positive integer greater than 1, such as about 1.1 to about 30, such as about 5 to about 30, such as about 10 to about 30, such as about 15 to about 30, such as about 20.

R⁶ and R⁷ of Formula (II) can be combined to form a cycloalkyl ring or an aryl ring, m represents the number of carbon atoms comprised within the ring. In some aspects, m is between 3 and 30, such as between 4 and 20, such as between 5 and 10, such as between 5 and 7. In one or more aspects wherein R⁶ and R⁷ are combined to form a cycloalkyl ring or an aryl ring, the ring can be substituted at any one or more corresponding positions and the substitution is any one or more alkyl groups, aryl groups, cycloalkyl groups, and heteroalkyl groups.

R⁶ and R⁷ of Formula (II) can be combined to form a cycloalkyl ring, the cycloalkyl ketone is a limonene-derived ketone or a terpene-derived ketone. In at least one aspect, the cycloalkyl ketone is a limonene-derived that is camphor. In at least one aspect, the cycloalkyl ketone is a terpene derived ketone selected from the group consisting of terpenone, leucosesterterpenone, farnesyl acetone, leucosesterlactone, pseudoionone, and muqubilone.

The ketonic polymer of Formula (II) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. In one or more aspects, the ketonic polymer of Formula (II) can havea PDI of about 1.01 to about 5.0, such as about 1.1 to about 4, such as about 1.5 to about 3.5, such as about 2 to about 3, as determined by GPC.

The ketonic polymer of Formula (II) can have a glass transition temperature (Tg) of about 50° C. to about 200° C., such as about 55° C. to about 100° C., such as about 60° C. to about 100° C., such as about 65° C. to about 80° C., as determined by DSC.

In some aspects, the ketonic polymer to undergo post-polymerization modification formed from cyclohexanone and formaldehyde, and is represented by Formula (III):

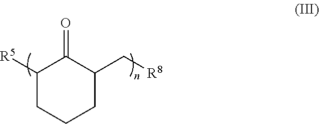

wherein R⁵ is represented by

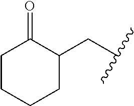 [SMILES: *CC1CCCCC1=O]

### and R⁸ is —OH.

The ketonic polymer of Formula (III) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/molas determined by GPC. The ketonic polymer of Formula (III) can have a PDI of about 1.01 to about 5.0, such as about 1.1 to about 4, such as about 1.5 to about 3.5, such as about 2 to about 3, as determined by GPC.

As previously described above, a polymeric Schiff base can be synthesized via post-polymerization modification of a ketonic polymer that is brought into contact with one or more thiosemicarbazides, thiocarbazides, or any suitable thiocarbonyl-containing compound having one or more terminal (—NH₂) groups, in the presence of a catalytic amount of an acid catalyst, to form pendent Schiff base structures along the polymer backbone.

In one or more aspects, the ketonic polymer undergoing post-polymerization modification is brought into contact with a thiosemicarbazide that is represented by Formula (IV):

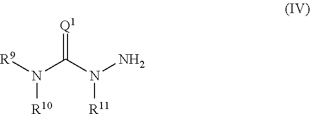

wherein:
Q¹ is oxygen or sulfur; and
each R⁹, R¹⁰, and R¹¹ is independently hydrogen, amino, aryl, alkyl, cycloalkyl, or heteroaryl.

The ketonic polymer to undergo post-polymerization modification is brought into contact with a thiosemicarbazide of Formula (IV) that is represented by

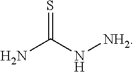

In some aspects, which can be combined with other aspects herein, the post-polymerization modification reaction (PPM) is conducted as a solution phase reaction or a bulk phase reaction comprising contacting the ketonic polymer with one or more thiosemicarbazide molecules, while in the presence of a catalytic amount of an acid catalyst. When the PPM is conducted as a solution phase, the reaction may be conducted in any one or more solvents.

Generally, the equivalent ratio of reactants in the PPM reaction are determined with respect to the functional equivalence of the ketonic polymer, wherein the functional equivalence of the ketonic polymer can be determined by any one or more suitable quantitative spectroscopic techniques (i.e., nuclear magnetic resonance spectroscopy (NMR)). For instance and without being bound by theory, if a ketonic polymer is undergoing a PPM reaction with a thiosemicarbazide, the functional equivalent ratio would be determined as the input number of ketone moieties relative to the input number of —NH—NH₂. In one or more aspects, the equivalent ratio of ketone to —NH—NH₂ used in the PPM reaction can be about 100:1 to about 1:100, such as about 75:1 to about 1:75, such as about 50:1 to about 1:50, such as about 25:1 to about 1:25, such as about 10:1 to about 1:10. In at least one aspect, the equivalent ratio of ketone to —NH—NH₂ is about 1:1.

The equivalent ratio of ketone to acid catalyst used in the PPM reaction can be about 100:1 to about 1:100, such as about 75:1 to about 1:75, such as about 50:1 to about 1:50, such as about 25:1 to about 1:25, such as about 10:1 to about 1:10. In at least one aspect, the equivalent ratio of ketone to —NH—NH₂ is about 1:0.1.

Upon completion of the PPM reaction, a Schiff base polymer is produced that can be represented by Formula (V):

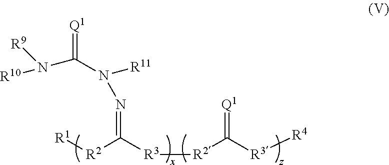

wherein;
each R₁ and R⁴ is independently aryl, alkyl, cycloalkyl, or heteroaryl;
each R², R^{2′}, R³, and R^{3′} is independently a bond, an aryl, alkyl, cycloalkyl, or heteroaryl, or combined to form a cycloalkyl ring or an aryl ring;
each Q¹ is independently oxygen or sulfur;
each of R⁹, R¹⁰, and R¹¹ is independently hydrogen, amino, aryl, alkyl, cycloalkyl, or heteroaryl;
x is the number of repeat units wherein the parent ketone is converted to a Schiff base; and
z is the number of repeat units wherein the parent ketone is unreacted.
R² and R³, and R^{2′} and R^{3′} of Formula (V) can be combined to form a cycloalkyl ring or an aryl ring.

The order of addition, rate of addition, and concentration of reactants can be considered when conducting a PPM reaction, e.g., to prevent gelation. For instance and without being bound by theory, if a polyketone is added dropwise to an extreme excess of thiosemicarbazide molecules, the ketone functionality will be largely consumed as the limiting reagent (assuming rapid reaction kinetics). In this case the functional average per individual molecule will favor the formation of pendant Schiff base moieties. In contrast, if a thiosemicarbazide is added dropwise to a solution containing an amount of polyketones, the thiosemicarbazide will be consumed as the limiting reagent. If the thiosemicarbazide molecule used in this case provides a reactive functionality of about 2 or greater, unwanted side reactions can occur potentially leading to gelation. In some aspects, the polyketone is introduced slowly dropwise to the thiosemicarbazide.

The conversion of the ketone to a Schiff base as a result of the PPM reaction can be about 1% to about 100% conversion (mol %), such as about 10% to about 95% conversion, such as about 20% to about 90% conversion, such as about 30% to about 85% conversion, such as about 40% to about 80% conversion, such as about 45% to about 75% conversion, such as about 50% to about 70% conversion. The percent conversion of the parent ketone to a Schiff base determines the corresponding values of x and z.

The ketonic polymer of Formula (V) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. The ketonic polymer of Formula (V) can have a PDI of about 1.01 to about 5.0, such as about 1.1 to about 4, such as about 1.5 to about 3.5, such as about 2 to about 3, as determined by GPC.

The ratio of x to z of Formula (V) can be about 1:10 to about 10:1, such as about 1:7.5 to about 7.5:1, such as about 1:5 to about 5:1, such as about 1:2.5 to about 2.5:1. In at least one aspect, the ratio of x to z is about 1:1 to about 3:1. In at least one aspect, x consists of a value of about 10 to about 15, and z consists of a value of about 10 to about 15. The Schiff base polymer of Formula (V) comprises a backbone architecture of at least one of a random copolymer, a block copolymer, an alternating copolymer, or a gradient copolymer. In one or more aspects, the Schiff base polymer of Formula (V) is a random copolymer. In one or more aspects, the Schiff base polymer of Formula (V) is a block copolymer.

TheSchiff base polymer of Formula (V) can have a glass transition temperature of about 50° C. to about 200° C., such as about 55° C. to about 100° C., such as about 60° C. to about 100° C., such as about 65° C. to about 80° C., as determined by DSC.

In at least one aspect wherein conversion of the parent ketone of Formula (V) to a Schiff base is 100%, the Schiff base polymer can be represented by:

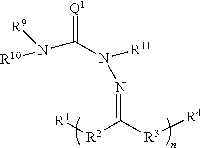

wherein;
each R¹ and R⁴ is independently aryl, alkyl, cycloalkyl, or heteroaryl, wherein R² and R³ may be combined to form a cycloalkyl or aryl ring;
each R² and R³ is independently a bond, an aryl, alkyl, cycloalkyl, or heteroaryl ring, wherein R² and R³ may be combined to form a cycloalkyl or aryl ring;
Q¹ is oxygen or sulfur;
each of R⁹, R¹⁰, and R¹¹ is independently hydrogen, amino, aryl, alkyl, cycloalkyl, or heteroaryl; and
n is a positive integer greater than 1, and is the sum of x and z.

In some aspects, a Schiff base polymer produced via a PPM reaction can be represented by Formula (VI):

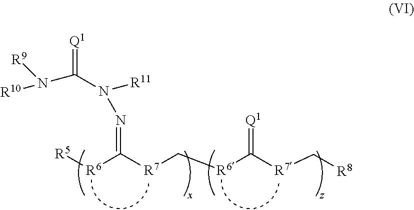

wherein;
each R⁵, R⁶, R^{6′}, R⁷, R^{7′}, and R⁸ is independently an aryl, alkyl, cycloalkyl, or heteroaryl ring, wherein R⁶ and R⁷, and R^{6′} and R^{7′} may be combined to form a cycloalkyl or aryl ring;
each Q¹ is independently oxygen or sulfur;
each of R⁹, R¹⁰, and R¹¹ is independently hydrogen, amino, aryl, alkyl, cycloalkyl, or heteroaryl;
x is the number of repeat units wherein the parent ketone is converted to a Schiff base; and
z is the number of repeat units wherein the parent ketone is unreacted.

R⁶ and R⁷ of Formula (VI) can be combined to form a cycloalkyl ring or an aryl ring, m represents the number of carbon atoms comprised within the ring. m of Formula (VI) can be between 3 and 30, such as between 4 and 20, such as between 5 and 10, such as between 5 and 7. R⁶ and R⁷ of Formula (VI) can be combined to form a cycloalkyl ring or an aryl ring, the ring can be substituted at any one or more corresponding positions and the substitution is any one or more alkyl groups, aryl groups, cycloalkyl groups, and heteroalkyl groups.

R⁶ and R⁷ of Formula (VI) can be combined to form a cycloalkyl ring, the cycloalkyl ketone is a limonene-derived ketone or a terpene-derived ketone. In at least one aspect, the cycloalkyl ketone is a limonene-derived that is camphor. In at least one aspect, the cycloalkyl ketone is a terpene derived ketone selected from the group consisting of terpenone, leucosesterterpenone, farnesyl acetone, leucosesterlactone, pseudoionone, and muqubilone.

The conversion of the parent ketone of Formula (VI) to a Schiff base can be about 1% to about 100% conversion, such as about 10% to about 95% conversion, such as about 20% to about 90% conversion, such as about 30% to about 85% conversion, such as about 40% to about 80% conversion, such as about 45% to about 75% conversion, such as about 50% to about 70% conversion. The percent conversion of the parent ketone to a Schiff base determines the corresponding values of x and z.

Theketonic polymer of Formula (VI) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. The ketonic polymer of Formula (VI) can have a PDI of about 1.01 to about 5.0, such as about 1.1 to about 4, such as about 1.5 to about 3.5, such as about 2 to about 3, as determined by GPC.

Theratio of x to z of Formula (VI) can be about 1:10 to about 10:1, such as about 1:7.5 to about 7.5:1, such as about 1:5 to about 5:1, such as about 1:2.5 to about 2.5:1. In at least one aspect, the ratio of x to z is about 1:1 to about 3:1. In at least one aspect, n consists of a value of about 10 to about 15, and m consists of a value of about 10 to about 15. The Schiff base polymer of Formula (VI) comprises a backbone architecture of at least one of a random copolymer, a block copolymer, an alternating copolymer, or a gradient copolymer. In one or more aspects, the Schiff base polymer of Formula (VI) is a random copolymer. In one or more aspects, the Schiff base polymer of Formula (VI) is a block copolymer.

The Schiff base polymer of Formula (VI) can have a glass transition temperature of about 50° C. to about 200° C., such as about 55° C. to about 100° C., such as about 60° C. to about 100° C., such as about 65° C. to about 80° C., as determined by DSC.

In at least one aspect wherein conversion of the parent ketone of Formula (VI) to a Schiff base is 100%, the Schiff base polymer can be represented by:

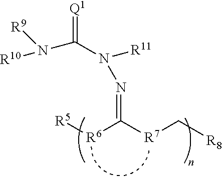

wherein;
each R⁵, R⁶, R⁷, and R⁸ is independently an aryl, alkyl, cycloalkyl, or heteroaryl ring, wherein R⁶ and R⁷ may be combined to form a cycloalkyl or aryl ring;
Q¹ is oxygen or sulfur;
each of R⁹, R¹⁰, and R¹¹ is independently hydrogen, amino, aryl, alkyl, cycloalkyl, or heteroaryl; and
n is a positive integer of greater than 1 to about 30.

In at least one aspect, the ketonic polymer implemented in the PPM reaction is a cyclohexanone-formaldehyde polymer. In at least one aspect wherein conversion of the parent ketone is 100%, the Schiff base polymer derived from a cyclohexanone-formaldehyde polymer can be represented by

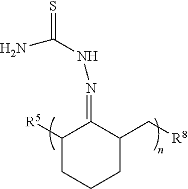

wherein:

R⁵ and R⁸ are independently an aryl, alkyl, cycloalkyl, or heteroaryl ring, and n is a positive integer of greater than 1 to about 30.

In at least one aspect wherein conversion of the parent ketone of Formula (VI) to a Schiff base is 100%, can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. Furthermore, the Schiff base polymer of Formula (VI) can have a PDI of about 1.01 to about 5.0, such as about 1.1 to about 4, such as about 1.5 to about 3.5, such as about 2 to about 3, as determined by GPC.

In at least one aspect wherein conversion of the parent ketone of Formula (VI) to a Schiff base is 100%, n consists of a value of about 10 to about 15. The Schiff base polymer of Formula (VI) can comprise a backbone architecture of at least one of a random copolymer, a block copolymer, an alternating copolymer, or a gradient copolymer. In one or more aspects, the Schiff base polymer is a random copolymer.

TheSchiff base polymer of Formula (VI), wherein conversion of the parent ketone can have to a Schiff base is 100%, a glass transition temperature of about 50° C. to about 200° C., such as about 55° C. to about 100° C., such as about 60° C. to about 100° C., such as about 65° C. to about 80° C.

In some aspects, which can be combined with other aspects herein, the Schiff base polymer is represented by Formula (VII):

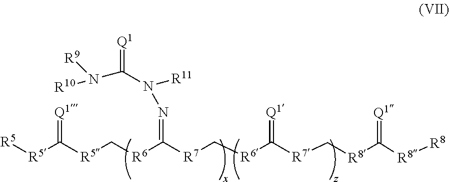

wherein:
each of R⁵ and R⁸ is independently hydrogen or —CH₂OH;
each of R⁶, R⁷, R^{6′}, R^{7′}, R^{5′}, R^{5″}, R^{8′}, and R^{8″} is independently aryl, alkyl, cycloalkyl, or heteroaryl, wherein R⁶ and R⁷, R^{6′} and R^{7′}, R^{5′} and R^{5″}, and R^{8′} and R^{8″} independently may combine to form a cycloalkyl ring or an aryl ring;
each of R⁹, R¹⁰, and R¹¹ is independently hydrogen, amino, aryl, alkyl, cycloalkyl, or heteroaryl;
each of Q¹ and Q^{1′} is independently oxygen or sulfur;
each of Q^{1″} and Q^{1″} is independently oxygen, sulfur, or

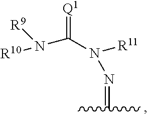

wherein each instance of Q^{1′} is independently oxygen or sulfur, and each instance of R⁹, R¹⁰ and R¹¹ is independently hydrogen, amino, aryl, alkyl, cycloalkyl, or heteroaryl,
x is a positive integer, z is 0 or a positive integer, x+z is such that the polymer represented by Formula (VII) has a molecular weight of about 400 g/mol to about 2,000 g/mol, and the polymer represented by Formula (VII) is a block copolymer or a random copolymer.

In some aspects, which can be combined with other aspects herein, the polymer represented by Formula (VII) can comprise various components. In one or more alternative aspects, each of R⁶, R^{6′}, R^{5′}, and R^{8′} is phenyl, each of R⁷, R^{7′}, and R^{5″} is methylene, and R^{8″} is methyl or methylene substituted with —CH₂OH. In one or more alternative aspects, each of Q¹ and Q^{1′} is oxygen and each of R⁹, R¹⁰, and R¹¹ is hydrogen. In one or more alternative aspects, each of R⁶ and R⁷, R^{6′} and R^{7′}, R^{5′} and R^{5″}, and R^{8′} and R^{8″} independently may combine to form a cycloalkyl ring, such as a cyclohexyl ring.

The ketonic polymer of Formula (VII) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. The ketonic polymer of Formula (VII) can have a PDI of about 1.01 to about 5.0, such as about 1.1 to about 4, such as about 1.5 to about 3.5, such as about 2 to about 3, as determined by GPC.

In some aspects, which can be combined with other aspects herein, the ratio of x: z of Formula (VII) is about 0.1:1 to about 1:0.1, alternatively about 1:1 to about 3:1. In at least one alternative aspect, x has a value of about 10 to about 15, and m has value of about 10 to about 15.

The Schiff base polymer of Formula (VII) can have a glass transition temperature of about 50° C. to about 200° C., such as about 55° C. to about 100° C., such as about 60° C. to about 100° C., such as about 65° C. to about 80° C., as determined by DSC.

### Formation of Schiff Base Separated Ketonic Resins

In some aspects, which can be combined with other aspects herein, a Schiff base polymer is formed by contacting a di-carbonyl (e.g. a diketone or a dialdehyde) with one or more thiocarbazide, thiosemicarbazide, or any suitable thiocarbonyl-containing compound having one or more terminal (—NH₂) groups.

In some aspects, which can be combined with other aspects herein, a Schiff base can be represented by Formula (VIII):

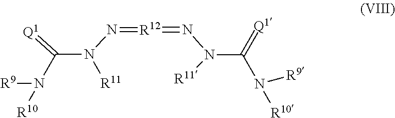

wherein:
each of Q¹ and Q^{1′} is independently oxygen or sulfur;
R¹² is aryl, alkyl, cycloalkyl, or heteroaryl; and
each of R⁹, R^{9′}, R¹⁰, R^{10′}, R¹¹, and R^{11′} is independently hydrogen, amino, aryl, alkyl, cycloalkyl, or heteroaryl.

R¹² of Formula (VIII) can be represented by any one or more of

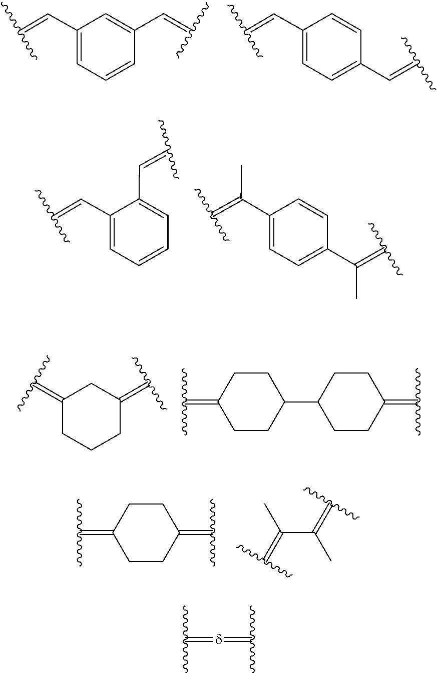

wherein δ is an aliphatic carbon chain.

δ can be an aliphatic carbon chain. In one or more aspects, which can be combined with other aspects herein, δ is a C₁-C₈ aliphatic carbon chain, such as methyl, ethyl, propyl, butyl, pentyl, hexyl, octyl or an isomer thereof, or a combination thereof.

A Schiff base of Formula (VIII) can be represented by

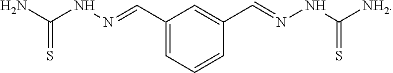 [SMILES: NC(=S)N/N=C/c1cccc(/C=N/NC(N)=S)c1]

A Schiff base polymer may be formed using any one or more appropriate polymerization, PPM, coupling reactions, and combinations thereof. In one or more aspects, the process of producing a Schiff base separated resin is selected from a sequential reaction process or an in-situ reaction process. In at least one aspect, the Schiff base polymer is formed via an in-situ process, wherein the Schiff base is brought into contact with formaldehyde, one or more ketone containing monomers, and a catalytic amount of a base catalyst. In at least one aspect, a Schiff base polymer is formed via a sequential reaction process, wherein a Schiff base above is first reacted with formaldehyde to form a product having one or more alcohol moieties followed by subsequent polymerization reactions. In one or more aspects the alcohol functionalized reaction product of the Schiff base and formaldehyde can be represented by Formula (IX):

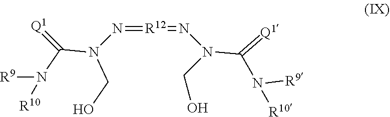

wherein:
each of Q¹ and Q^{1′} is independently oxygen or sulfur;
R¹² is aryl, alkyl, cycloalkyl, or heteroaryl; and
each of R⁹, R^{9′}, R¹⁰, and R^{10′} is independently hydrogen, amino, aryl, alkyl, cycloalkyl, heteroaryl, or methylol group.

In some aspects, which can be combined with other aspects herein, a Schiff base polymer represented by Formula (X):

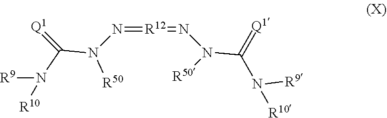

wherein;
R¹² is aryl, alkyl, cycloalkyl, or heteroaryl;
each of R⁹, R^{9′}, R¹⁰, and R^{10′} is independently hydrogen, amino, aryl, alkyl, cycloalkyl, or heteroaryl; and
R⁵⁰ and R^{50′} are independently polymer chains formed from the reaction between the one or more ketone containing monomers, formaldehyde, and the catalytic amount of base catalyst.

R⁵⁰ and R^{50′} of Formula (X) can be independently represented by:

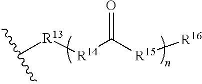

wherein;
each R¹³ is —CH₂—;
each of R¹⁴ and R¹⁵ is independently aryl, alkyl, cycloalkyl, heteroaryl, or combined to form a cycloalkyl ring or an aryl ring;
each R¹⁶ is independently —OH or —CH₂OH; and
n is independently positive integer greater than 1 to about 30.

R¹⁴ and R¹⁵ and R^{14′} and R^{15′} of Formula (X) can be combined to form a cycloalkyl ring or an aryl ring.

n of Formula (X) can be a positive integer greater than 1, such as about 1.1 to about 30, such as about 5 to about 30, such as about 10 to about 30, such as about 15 to about 30, such as about 20. The ketonic polymer of Formula (X) can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. The ketonic polymer of Formula (X) can have a PDI of about 1.01 to about 5.0, such as about 1.1 to about 4, such as about 1.5 to about 3.5, such as about 2 to about 3.

The Schiff base polymer of Formula (X) can have a glass transition temperature of about 50° C. to about 200° C., such as about 55° C. to about 100° C., such as about 60° C. to about 100° C., such as about 65° C. to about 80° C., as determined by DSC.

In some aspects, which can be combined with other aspects herein, the ketone containing monomer implemented in the formation of the Schiff base polymer of Formula (X) can be a cycloalkyl ketone or an aryl ketone, such that R⁵⁰ and R^{50′} can be independently represented by:

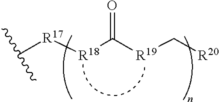

wherein:
each R¹⁷ is —CH₂;
each of R¹⁸ and R¹⁹ are combined to form a cycloalkyl or aryl ring;
each R²⁰ is —OH; and
each n is independently positive integers of greater than 1 to 30.

R¹⁸ and R¹⁹ of Formula (X) can be combined to form a cycloalkyl ring or an aryl ring. In one or more aspects wherein R¹⁸ and R¹⁹ are combined to form a cycloalkyl ring or an aryl ring, the ring can be substituted at any one or more corresponding positions and the substitution is any one or more alkyl groups, aryl groups, cycloalkyl groups, or heteroalkyl groups.

R¹⁸ and R¹⁹ of Formula (X) can be combined to form a cycloalkyl ketone, the cycloalkyl ketone is a limonene-derived ketone or a terpene-derived ketone. In at least one aspect, the cycloalkyl ketone is a limonene-derived that is camphor. In at least one aspect, the cycloalkyl ketone is a terpene derived ketone selected from the group consisting of terpenone, leucosesterterpenone, farnesyl acetone, leucosesterlactone, pseudoionone, and muqubilone.

In some aspects, wherein R¹⁸ and R¹⁹ of Formula (X) are combined to form a cycloalkyl ketone, n is a positive integer greater than 1, such as about 1.1 to about 30, such as about 5 to about 30, such as about 10 to about 30, such as about 15 to about 30, such as about 20. In one or more aspects, wherein R¹⁸ and R¹⁹ of Formula (X) are combined to form a cycloalkyl ketone, the ketonic polymer has a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. In one or more aspects, the ketonic polymer of Formula (X), wherein R¹⁸ and R¹⁹ are combined to form a cycloalkyl ketone, can have a PDI of about 1.01 to about 5.0, such as about 1.1 to about 4, such as about 1.5 to about 3.5, such as about 2 to about 3, as determined by GPC.

The ketonic polymer of Formula (X), wherein R¹⁸ and R¹⁹ are combined to form a cycloalkyl ketone, can have a glass transition temperature of about 50° C. to about 200° C., such as about 55° C. to about 100° C., such as about 60° C. to about 100° C., such as about 65° C. to about 80° C., as determined by DSC.

A Schiff base polymer can be formed by a PPM reaction by contacting the ketonic resin, represented by Formula (X), with one or more thiosemicarbazide molecules. The resulting ketonic resin, represented by Formula (X), can have R⁵⁰ and R^{50′} independently represented by Formula (XI):

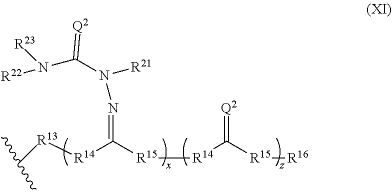

wherein:
each R¹³ is —CH₂;
each R¹⁶ is independently —CH₂OH or —OH;
each R¹⁴ and R¹⁵ is independently an aryl, alkyl, cycloalkyl, or heteroaryl ring;
each Q² is independently selected from oxygen and sulfur;
each of R²¹, R²², and R²³ is independently hydrogen, amino, aryl, alkyl, cycloalkyl, or heteroaryl;
each x is independently the average number of repeat units wherein the parent ketone units are converted to a Schiff base; and
each z is independently the average number of repeat units wherein the parent ketone units are unreacted.

R¹⁴ and R¹⁵ of Formula (XI) can be combined to form a cycloalkyl ring or an aryl ring.

The conversion of the parent ketone of Formula (X) to a Schiff base can be about 1% to about 100% conversion, such as about 10% to about 95% conversion, such as about 20% to about 90% conversion, such as about 30% to about 85% conversion, such as about 40% to about 80% conversion, such as about 45% to about 75% conversion, such as about 50% to about 70% conversion. The percent conversion of the parent ketone to a Schiff base determines the corresponding values of x and z.

The Schiff base polymer of Formula (X), wherein R⁵⁰ and R^{50′} are independently represented by Formula (XI), can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol, as determined by GPC. The Schiff base polymer of Formula (X), wherein R⁵⁰ and R^{50′} are independently represented by Formula (XI), can have a PDI of about 1.01 to about 5.0, such as about 1.1 to about 4, such as about 1.5 to about 3.5, such as about 2 to about 3, as determined by GPC.

The ratio of x to z of Formula (X), wherein R⁵⁰ and R^{50′} are independently represented by Formula (XI), can be about 1:10 to about 10:1, such as about 1:7.5 to about 7.5:1, such as about 1:5 to about 5:1, such as about 1:2.5 to about 2.5:1. In at least one aspect, the ratio of one or more of x to z is about 1:1 to about 3:1. In at least one aspect, each x independently consists of a value of about 10 to about 15, and z independently consists of a value of about 10 to about 15. The Schiff base polymer of Formula (X), wherein R⁵⁰ and R^{50′} are independently represented by Formula (XI), can comprise a backbone architecture of at least one of a random copolymer, a block copolymer, an alternating copolymer, a gradient copolymer, or a combination thereof. In one or more aspects, the Schiff base polymer is a random copolymer. In one or more aspects, the Schiff base polymer is a block copolymer.

The Schiff base polymer of Formula (X), wherein R⁵⁰ and R^{50′} are independently represented by Formula (XI), can have a glass transition temperature of about 50° C. to about 200° C., such as about 55° C. to about 100° C., such as about 60° C. to about 100° C., such as about 65° C. to about 80° C., as determined by DSC.

In one or more alternative aspects, a Schiff base can be represented by Formula

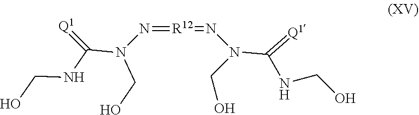

wherein:
each of Q¹ and Q^{1′} is independently oxygen or sulfur; and
R¹² is aryl, alkyl, cycloalkyl, or heteroaryl.

In some aspects, which can be combined with other aspects herein, a Schiff base polymer represented by Formula (XVI):

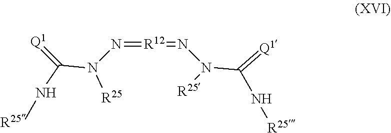

wherein;
R¹² is aryl, alkyl, cycloalkyl, or heteroaryl; and
each of R²⁵, R^{25′}, R²⁵″, and R^{25′″} are independently polymer chains formed from the reaction between the one or more ketone containing monomers, formaldehyde, and the catalytic amount of base catalyst.

In some aspects, which can be combined with other aspects herein, R²⁵, R^{25′}, R²⁵″, and R^{25′″} are independently represented by:

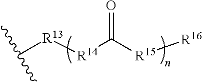

wherein:
each of R¹³ is —CH₂—;
each of R¹⁴ and R¹⁵ is independently alkyl, cycloalkyl, or combined to form a cycloalkyl ring or an aryl ring;
each R¹⁶ is independently —OH or —CH₂OH; and
n is a positive integer greater than 1 to about 30.

R¹⁴ and R¹⁵, R^{14′} and R^{15′}, R¹⁴″ and R¹⁵″, and R^{14′″} and R^{15′″} of Formula (XVI) can be combined to form a cycloalkyl ring or an aryl ring.

n of each of R²⁵, R^{25′}, R²⁵″, and R^{25′″} of Formula (XVI) wherein each of R¹⁴ and R¹⁵ is independently alkyl, cycloalkyl, or combined to form a cycloalkyl ring or an aryl ring can independently be a positive integer greater than 1, such as about 1.1 to about 30, such as about 5 to about 30, such as about 10 to about 30, such as about 15 to about 30, such as about 20.

Theketonic polymer of Formula (XVI) wherein of each of R¹⁴ and R¹⁵ is independently alkyl, cycloalkyl, or combined to form a cycloalkyl ring or an aryl ring can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol. The ketonic polymer of Formula (XVI) wherein of each of R¹⁴ and R¹⁵ is independently alkyl, cycloalkyl, or combined to form a cycloalkyl ring or an aryl ring can have a PDI of about 1.01 to about 5.0, such as about 1.1 to about 4, such as about 1.5 to about 3.5, such as about 2 to about 3.

The ketonic polymer of Formula (XVI) wherein of each of R¹⁴ and R¹⁵ is independently alkyl, cycloalkyl, or combined to form a cycloalkyl ring or an aryl ring can have a glass transition temperature of about 50° C. to about 200° C., such as about 55° C. to about 100° C., such as about 60° C. to about 100° C., such as about 65° C. to about 80° C.

The ketone containing monomer implemented in the formation of the Schiff base polymer is a cycloalkyl ketone or an aryl ketone, such that R²⁵, R^{25′}, R²⁵″, and R^{25′″} of Formula (XVI) can be independently represented by:

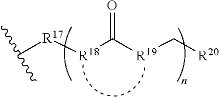

wherein:
each of R¹⁷ is —CH₂—;
each of R¹⁸ and R¹⁹ are combined to form a cycloalkyl ring or an aryl ring;
each of R²⁰ is —OH; and
each n is a positive integer greater than 1.

Each of R¹⁸ and R¹⁹ of Formula (XVI) can be combined to form a cycloalkyl ring or an aryl ring, the ring can be substituted at any one or more corresponding positions and the substitution is any one or more alkyl groups, aryl groups, cycloalkyl groups, and heteroalkyl groups.

In one or more aspects wherein one or more of R¹⁸ and R¹⁹ of Formula (XVI) can be combined to form a cycloalkyl ring, the cycloalkyl ketone is a limonene-derived ketone or a terpene-derived ketone. In at least one aspect, the cycloalkyl ketone is a limonene-derived that is camphor. In at least one aspect, the cycloalkyl ketone is a terpene derived ketone selected from the group consisting of terpenone, leucosesterterpenone, farnesyl acetone, leucosesterlactone, pseudoionone, and muqubilone.

n of each of R²⁵, R^{25′}, R²⁵″, and R^{25′″} of Formula (XVI) wherein each of R¹⁸ and R¹⁹ are combined to form a cycloalkyl ring or an aryl ring can independently be a positive integer greater than 1, such as about 1.1 to about 30, such as about 5 to about 30, such as about 10 to about 30, such as about 15 to about 30, such as about 20. The ketonic polymer of Formula (XVI), wherein each of R¹⁸ and R¹⁹ are combined to form a cycloalkyl ring or an aryl ring, can have a Mw of about 400 g/mol to about 20,000 g/mol, such as about 500 g/mol to about 15,000 g/mol, such as about 600 g/mol to about 10,000 g/mol, such as about 700 g/mol to about 5,000 g/mol, such as about 750 g/mol to about 1,000 g/mol, such as about 750 g/mol to about 850 g/mol. The ketonic polymer of Formula (XVI), wherein each of R¹⁸ and R¹⁹ are combined to form a cycloalkyl ring or an aryl ring, can have a PDI of about 1.01 to about 5.0, such as about 1.1 to about 4, such as about 1.5 to about 3.5, such as about 2 to about 3.

The ketonic polymer of Formula (XVI), wherein each of R¹⁸ and R¹⁹ are combined to form a cycloalkyl ring or an aryl ring, can have a glass transition temperature of about 50° C. to about 200° C., such as about 55° C. to about 100° C., such as about 60° C. to about 100° C., such as about 65° C. to about 80° C.

A Schiff base polymer can be formed by a PPM reaction by contacting the ketonic resin of Formula (XVI) with one or more thiosemicarbazide molecules. The resulting ketonic resin can be represented by Formula (XVI), wherein R²⁵, R^{25′}, R²⁵″, and R^{25′″} are represented by Formula (XVII):

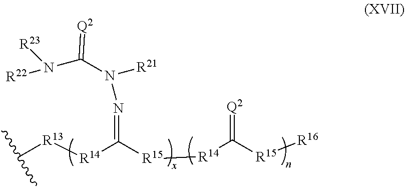

wherein:
each of R¹³ is —CH₂—;
each of R¹⁴ and R¹⁵ is independently aryl, alkyl, cycloalkyl, heteroaryl, or combined to form a cycloalkyl ring or an aryl ring;
   each R¹⁶ of is independently —OH or —CH₂OH;
   each Q² is independently oxygen or sulfur;
   each of R²¹, R²², and R²³ is independently hydrogen, amino, aryl, alkyl, cycloalkyl, or heteroaryl;
   each x is independently the number of repeat units wherein the parent ketone units are converted to a Schiff base; and
   each z is independently the number of repeat units wherein the parent ketone units are unreacted.

In reference to Formula (XVII) one or more of R¹⁴ and R¹⁵ are combined to form a cycloalkyl ring or an aryl ring.

The conversion of the parent ketone of Formula (XVI) to a Schiff base can be about 1% to about 100% conversion, such as about 10% to about 95% conversion, such as about 20% to about 90% conversion, such as about 30% to about 85% conversion, such as about 40% to about 80% conversion, such as about 45% to about 75% conversion, such as about 50% to about 70% conversion. The percent conversion of the parent ketone to a Schiff base determines the corresponding values of x and z.

In one or more alternative aspects, the Schiff base polymer can be represented by Formula (XXV):

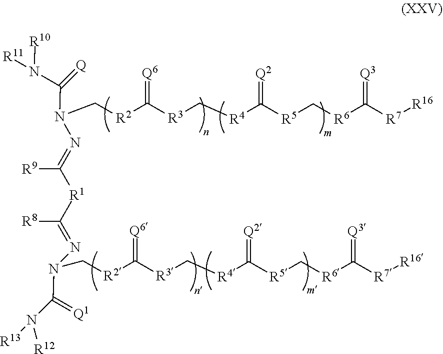

wherein:
R¹ is aryl, alkyl, cycloalkyl, or heteroaryl;
each R¹⁰ and R¹² is independently hydrogen, alkyl, cycloalkyl, aryl, or heteroaryl;
each of R⁸ and R⁹ is independently hydrogen, alkyl, cycloalkyl, aryl, or heteroaryl;
each of R¹¹ and R¹³ is independently hydrogen or represented by the formula:

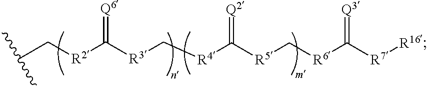

each instance of R², R³, R⁴, R⁵, R⁶, R⁷, R^{2′}, R^{3′}, R^{4′}, R^{5′}, R^{6′}, R^{7′} is independently aryl, alkyl, cycloalkyl, or heteroaryl, wherein R² and R³, R⁴ and R⁵, R⁶ and R⁷, R^{2′} and R^{3′}, R^{4′} and R^{5′}, and R^{6′} and R⁷ independently may combine to form a cycloalkyl ring or an aryl ring;
each instance of R¹⁶ and R^{16′} is independently hydrogen or —CH₂OH;
each instance of Q¹, Q², Q^{2′}, and Q⁴ is independently oxygen or sulfur;
each instance of Q³, Q^{3′}, Q⁶, and Q^{6′} is independently oxygen, sulfur, or

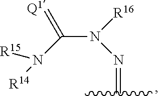

wherein each instance of Q^{1′} is independently oxygen or sulfur, and each instance of R¹⁴, R¹⁵ and R¹⁶ is independently hydrogen, aryl, alkyl, cycloalkyl, or heteroaryl,
each instance of n and n′ is independently a positive integer;
each instance of m and m′ is independently 0 or a positive integer, and
the polymer represented by Formula (XXV) is a block copolymer or a random copolymer.

R¹ of Formula (XXV) is aryl, such as

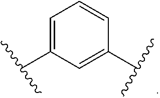 [SMILES: *c1cccc(*)c1]

Each instance of Q¹, Q², Q^{2′}, Q⁴, Q³, Q^{3′}, Q⁶, and Q^{6′} in Formula (XXV) is oxygen. Each instance of Q¹, Q², Q^{2′}, and Q⁴, Formula (XXV), is oxygen and each instance of Q⁶, and Q^{6′} is independently

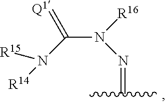

wherein each instance of Q^{1′} is oxygen, and each instance of R¹⁴, R¹⁵ and R¹⁶ is hydrogen.

In reference to Formula (XXV), the ratio of n to m is about 0.1:1 to about 1:0.1, such as about 1:1 to about 3:1. Each instance of R² and R³, R⁴ and R⁵, R⁶ and R⁷, R^{2′} and R^{3′}, R^{4′} and R^{5′}, and R^{6′} and R^{7′}, of Formula (XXV), are independently combined to form an alkyl ring. In some aspects, each instance of the alkyl ring is a cyclohexyl ring.

In some aspects, a metal substrate includes the polymer of Formula (XXV) disposed thereon.

In some aspects, a method of forming the polymer of Formula (XXV) includes forming an intermediate polymer by introducing formaldehyde and a ketone with a first semicarbazide represented by the formula:

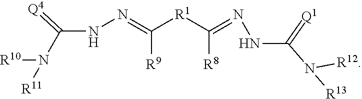

Each of Q¹ and Q⁴ is independently oxygen or sulfur, R¹ is aryl, alkyl, cycloalkyl, or heteroaryl; each of R⁸ and R⁹ is independently hydrogen, alkyl, cycloalkyl, aryl, or heteroaryl; and each of R¹⁰, R¹¹, R¹², and R¹³ is independently hydrogen, aryl, alkyl, cycloalkyl, or heteroaryl. In some aspects, the method can further include introducing the intermediate polymer with a second semicarbizide represented by the formula:

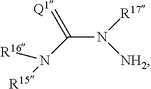

wherein Q^{1″} is oxygen or sulfur, and each of R^{15′}, R^{16′} and R^{17′} is independently hydrogen, aryl, alkyl, cycloalkyl, or heteroaryl. In some aspects, R¹ is aryl, such as

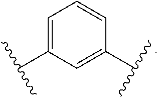 [SMILES: *c1cccc(*)c1]

In some aspects,, the ketone is a cyclic alkyl ketone, such as cyclohexanone or acetophenone. In some aspects, the ketone is a limonene-derived ketone or a terpene-derived ketone. In some aspects, the ketone is a terpene-derived ketone selected from the group consisting of terpenone, leucosesterterpenone, farnesyl acetone, leucosesterlactone, pseudoionone, and muqubilone.
Deposition of Schiff Base Polymers onto Substrates

In some aspects, a method comprises applying a Schiff base polymer of the present disclosure (e.g., dispersed in a solvent) to a substrate, such as a metal substrate. The Schiff base polymer can be applied over a metal by spraying, brushing, roller coating, or dipping, e.g., for complete coating of a surface. A material that can be applied by a range of methods allows for uses of this technology to be scaled up. The aircraft industry might use spray, whereas an automotive company might use a dip tank for auto frames and rail car manufacturers might use roller or brush methods. The Schiff base polymer can be dispersible in an aqueous solvent, an organic solvent, or an aqueous-organic solvent blend. Functional groups of the Schiff base ketonic polymer can be reacted with other components, e.g., to increase its dispersibility.

In certain aspects, the Schiff base ketonic polymer provides corrosion protection over a long period of time as determined by pass/fail of a 3000 hour ASTM B117 salt fog exposure test. The Schiff base ketonic polymer can form a continuous film that provides corrosion inhibition for metal surfaces for a prolonged period of time. The Schiff base polymer can form a coating to inhibit corrosion of metal surfaces of aerospace vehicles, cars, trucks, trains, boats, ships, buildings, bridges, and other metal components.

### Schiff Base Polymers and Metals

A Schiff base ketonic polymer of the present disclosure may be dispersible in a solvent. The Schiff base polymer may be in a composition with (e.g., dispersed with or ionically bonded to) one or more metals. Such metals can promote corrosion inhibition. For example, a metal can be a cationic species of a transition metal.

Metals can be in the form of a cation or a metal salt. For example, a metal may be selected from alkali earth metals, transition metals and rare earth metal salts, for example a group consisting of Zn, La, Pr, Nd, Sm, Eu, Gd, Tb, Dy, Ho, Er, Tm, Yb, Lu, Ce, Co, Y, Bi, Cd, Pb, Ag, Sb, Sn, Cu, Fe, Ni, Li, Ca, Sr, Mg, Zr, Nd, Ba, Sc, and any combinations thereof. For example, a metal may be selected from a group consisting of Zn, La, Pr, Ce, Co, Y, Ca, Sr, Ba, Sc, and Zr. The metals may be selected from at least one of Zn, Pr and Ce. The metal may be Zn. The metal may be Ce. The metal may be Pr. Some examples of salts that may be used are nitrate salts, chloride salts, acetate salts, or any combinations thereof.

It will be appreciated that the metals may have any suitable oxidation state. For example, the typical oxidation state for Zn is +2. The typical oxidation states for Pr are +2, +3 and/or +4. The typical oxidation states for Ce are +2, +3 and +4. It will be appreciated that various combinations and groups of the above-mentioned metal salts, may be used in the compositions of the present disclosure.

### Substrates for Corrosion Protection

Substrates that may be protected from corrosion by a Schiff base ketonic polymer or composition thereof may be any suitable substrate, such as a metal substrate or plastic substrate. The metal substrate can include any substrate material having at least a portion of its surface being metallic, for example a portion of its external surface being metallic. The metal substrate may comprise any metal needing protection from corrosion. The metal substrate can include a metal or alloy selected from aluminum, for example aluminum alloys. The metal substrate can be an aluminum alloy, for example alloys of aluminum with one or more metals selected from the group consisting of copper, magnesium, manganese, silicon, tin, zinc, and combinations thereof. An aluminum alloy can be an alloy comprising copper. The metal substrate can be a copper-containing alloy, such as copper-containing aluminum alloy. The amount of copper in the alloy can be about 1 wt % to about 20 wt %, about 1 wt % to about 18 wt %, about 1 wt % to about 10 wt %, or about 1 wt % to about 6 wt %. The aluminum alloy can be an aerospace alloy, for example AA2XXX and AA7XXX type. For example the aluminum alloy can be AA2024 and AA7075 type. The aluminum alloy can be an automotive alloy, for example AA6XXX type. The aluminum alloy may be a marine alloy, for example AA5XXX type.

### Examples

### Synthesis of a Polymeric Schiff Base Via a PPM Reaction

A solution of thiosemicarbazide in 750 mL of ethanol was heated with stirring at 60° C. until the thiosemicarbazide was completed dissolved. A solution composed of 0.9 mL of HCl in 10 mL of ethanol was added dropwise to the solution of thiosemicarbazide. A solution composed of 10 g of ketonic resin in 50 mL of ethanol was added to the thiosemicarbazide solution over the course of 30 minutes at 78° C., followed by refluxing the solution for approximately 2-3 hours. The solution was then allowed to cool slowly to room temperature, producing a yellow solid precipitate. The solid was collected and washed further with ethanol. It will be appreciated by one of ordinary skill in the art, that greater/lesser volumes or concentrations of one or more of thiosemicarbazide, ethanol, HCl, and the ketonic resin may be used, as is contemplated herein, without departing from the experimental procedure. Formation of an Alcohol Functionalized Schiff Base

A solution composed of 24.3 g of formalin (37%), 1.4 g of Schiff base, and 15 mL of ethanol was heated and mixed at 60° C., followed by the addition of 0.025 mL of 20% NaOH. The temperature of the solution was then brought about 75° C. to about 80° C., and refluxed for 2-3 hours. A powder-like product was then obtained, washed with water and ethanol, and dried under vacuum at 50° C. It will be appreciated by one of ordinary skill in the art, that greater/lesser volumes or concentrations of one or more of formalin, the Schiff base, ethanol, and NaOH may be used, as is contemplated herein, without departing from the experimental procedure.

### Synthesis of a Schiff Base Spaced Polyketonic Resin Via a Sequential Reaction Process

A mixture of 49.1 g of cyclohexanone and 5 g of alcohol functionalized Schiff base was prepared, followed by the addition of a mixture composed of 16 g of formalin (37%) and 10 g of cyclohexane. The mixture was brought to a temperature of about 65° C. to about 70° C., and allowed to reflux, followed by the addition of a mixture composed of 100 mL of formalin (37%) and 3.64 mL of 20% NaOH. The reaction was allowed to proceed for 2 hours under basic conditions (e.g. pH=about 11-12). The viscous product was recovered by decanting the aqueous layer and washing with hot water until the filtrate becomes neutral. The resin was then dried under vacuum at 110° C. It will be appreciated by one of ordinary skill in the art, that greater/lesser volumes or concentrations of one or more of cyclohexanone, alcohol functionalized Schiff base, formalin, and NaOH may be used, as is contemplated herein, without departing from the experimental procedure.

### In-Situ Synthesis of a Schiff Base Spaced Polyketonic Resin

A mixture of 49.1 g of cyclohexanone and 1.4 g of Schiff base was prepared, followed by the addition of a mixture composed of 16 g of formalin (37%) and 10 g of cyclohexane. The mixture was brought to a temperature of about 65° C. to about 70° C., and allowed to reflux, followed by the addition of a mixture composed of 100 mL of formalin (37%) and 3.64 mL of 20% NaOH. The reaction was allowed to proceed for 2 hours under basic conditions (e.g. pH=about 11-12). The viscous product was recovered by decanting the aqueous layer and washing with hot water until the filtrate becomes neutral. The resin was then dried under vacuum at 110° C. It will be appreciated by one of ordinary skill in the art, that greater/lesser volumes or concentrations of one or more of cyclohexanone, alcohol functionalized Schiff base, formalin, and NaOH may be used, as is contemplated herein, without departing from the experimental procedure.

### Additional Aspects

The present disclosure provides, among others, the following aspects, each of which may be considered as optionally including any alternate aspects.
Clause 1. A polymer represented by Formula (V):

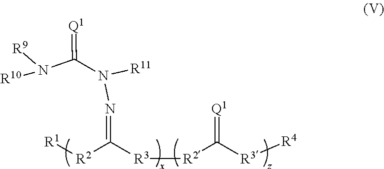

wherein;
each R¹ and R⁴ is independently a bond, aryl, alkyl, cycloalkyl, or heteroaryl, wherein R² and R³ and/or R^{2′} and R^{3′} independently may combine to form a cycloalkyl ring or an aryl ring;
each R², R^{2′}, R³, and R^{3′} is independently a bond, aryl, alkyl, cycloalkyl, or heteroaryl, wherein R² and R³ and/or R^{2′} and R^{3′} independently may combine to form a cycloalkyl ring or an aryl ring;
Q¹ is oxygen or sulfur;
each of R⁹, R¹⁰, and R¹¹ is independently hydrogen, amino, aryl, alkyl, cycloalkyl, or heteroaryl; and
x is a positive integer, z is 0 or a positive integer, x+z is such that the polymer represented by Formula (V) has a molecular weight of about 400 g/mol to about 20,000 g/mol, and the polymer represented by Formula (V) is a block copolymer, a random copolymer, an alternating copolymer, or a gradient copolymer.
Clause 2. The polymer of Clause 1, wherein the polymer represented by Formula (V) has a molecular weight of about 500 g/mol to about 15,000 g/mol and is either a block copolymer or a random copolymer.
Clause 3. The polymer of any Clauses 1 to 2, R² and R^{2′} are a bond and R³ and R^{3′} are selected from any one or more of

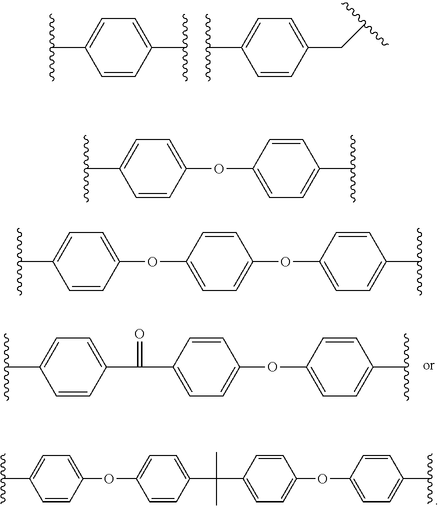

Clause 4. The polymer of any Clauses 1 to 2, wherein each of R² and R^{2′} is phenyl, each of R³ and R^{3′} is ethylene, and R¹ and R⁴ are independently phenyl or —CH₂OH.
Clause 5. The polymer of any Clauses 1 to 2, wherein each R² and R³ and R^{2′} and R^{3′} are combined to form a cycloalkyl ring or an aryl ring, such that the polymer can be represented by Formula (VI):

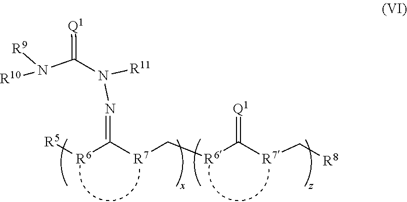

wherein;
each of R⁵ and R⁸ is independently an aryl, alkyl, cycloalkyl, or heteroaryl,
each of R⁶ and R⁷, and R^{6′} and R^{7′} is combined to form cycloalkyl or aryl;
Q¹ is oxygen or sulfur;
each of R⁹, R¹⁰, and R¹¹ is independently hydrogen, amino, aryl, alkyl, cycloalkyl, or heteroaryl; and
x is a positive integer, z is 0 or a positive integer, x+z is such that the polymer represented by Formula (VI) has a molecular weight of about 400 g/mol to about 20,000 g/mol, and the polymer represented by Formula (VI) is a block copolymer, a random copolymer, an alternating copolymer, or a gradient copolymer.
Clause 6. The polymer of Clause 5, wherein the rings formed by R⁶ and R⁷, and R^{6′} and R^{7′} are cycloalkyl rings.
Clause 7. The polymer of Clause 6, wherein the cycloalkyl rings are cyclohexyl rings.
Clause 8. The polymer of any Clauses 1 to 7, wherein each of R⁹, R¹⁰, and R¹¹ is hydrogen.
Clause 9. The polymer of any Clauses 1 to 8, wherein a ratio of x to z is about 0.1:1 to about 1:0.1.
Clause 10. The polymer of any Clauses 1 to 9, wherein the ratio of x to z is about 1:1 to about 3:1
Clause 11. A metal substrate comprising the polymer of any Clauses 1 to 10 disposed thereon.
Clause 12. A method of forming the polymer of any Clauses 1 to 11, comprising introducing formaldehyde with a ketone to form an intermediate polymer followed by treating the intermediate polymer with a carbazide/semicarbazide represented by the Formula (IV):

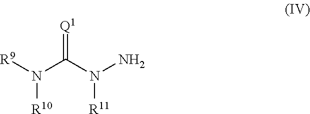

wherein:
Q¹ is oxygen or sulfur; and
each R⁹, R¹⁰, and R¹¹ is independently hydrogen, amino, aryl, alkyl, cycloalkyl, or heteroaryl.
Clause 13. The method of any Clauses 1 to 2, 5 to 6, and 8 to 12, wherein the ketone is a cycloalkyl ketone.
Clause 14. The method of any Clauses 1 to 2, 5 to 6, and 8 to 13, wherein the cycloalkyl ketone is cyclohexanone or acetophenone.
Clause 15. The method of any Clauses 1 to 2, 5 to 6, and 8 to 14, wherein the ketone is a limonene-derived ketone or a terpene-derived ketone.
Clause 16. The method of any Clauses 1 to 2, 5 to 6, and 8 to 15, wherein the ketone is a limonene-derived ketone that is camphor.
Clause 17. The method of any Clauses 1 to 2, 5 to 6, and 8 to 16, wherein the ketone is a terpene-derived ketone selected from the group consisting of terpenone, leucosesterterpenone, farnesyl acetone, leucosesterlactone, pseudoionone, and muqubilone.
Clause 18. A polymer represented by Formula (X):

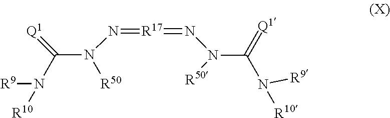

wherein;
R¹² is aryl, alkyl, cycloalkyl, or heteroaryl;
each of R⁹, R^{9′}, R¹⁰, and R^{10′} is independently hydrogen, amino, aryl, alkyl, cycloalkyl, or heteroaryl; and
R⁵⁰ and R^{50′} are independently polymer chains formed from the reaction between the one or more ketone containing monomers, formaldehyde, and the catalytic amount of base catalyst.
Clause 19. The polymer of Clause 18, wherein R¹² is selected from

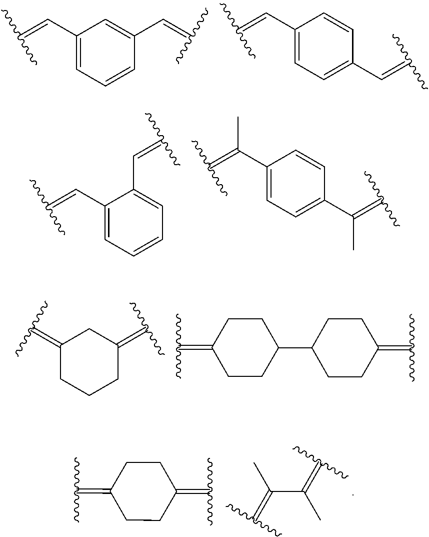

Clause 20. The polymer of any Clauses 18 to 19, wherein R⁵⁰ and R^{50′} are represented, respectfully, by Formulas (XI):

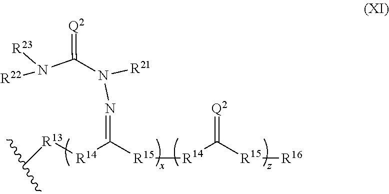

wherein:
each of R¹³ is —CH₂;
each R¹⁶ is independently —CH₂OH or —OH;
each R¹⁴ and R¹⁵ is independently aryl, alkyl, a bond, cycloalkyl, or heteroaryl ring, wherein R¹⁴ and R¹⁵ independently may combine to form a cycloalkyl ring or an aryl ring;
each Q² is oxygen or sulfur;
each of R²¹, R²², and R²³ is independently hydrogen, amino, aryl, alkyl, cycloalkyl, or heteroaryl;
each x independently is a positive integer, z independently is 0 or a positive integer, the sum of x and z is such that the polymer represented by Formula (XI) has a molecular weight of about 400 g/mol to about 20,000 g/mol, and the polymer represented by Formula (XI) is a block copolymer, a random copolymer, an alternating copolymer, or a gradient copolymer.
Clause 21. The polymer of any Clause 18 to 20, wherein the polymer represented by Formula (X) comprises a molecular weight of about 500 g/mol to about 15,000 g/mol and is either a block copolymer or a random copolymer.
Clause 22. The polymer of any Clauses 20 to 21, R¹⁴ and R^{14′} are a bond and R¹⁵ and R^{15′} are selected from any one or more of

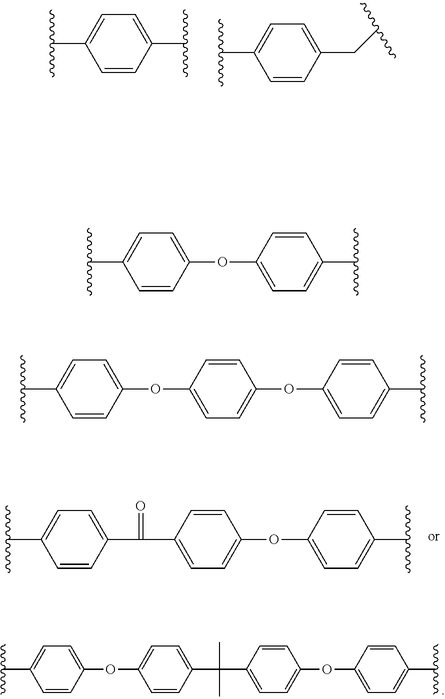

Clause 23. The polymer of any Clauses 20 to 21, wherein each of R¹⁴ and R^{14′} is phenyl, each R¹⁵ is ethylene, and R¹³ and R¹⁶ are independently phenyl or —CH₂OH.
Clause 24. The polymer of any Clauses 20 to 21, wherein each R¹⁴ and R¹⁵ are combined to form a cycloalkyl ring or an aryl ring.
Clause 25. The polymer of Clause 24, wherein the rings formed by R¹⁸ and R¹⁹ are cycloalkyl rings.
Clause 26. The polymer of Clause 25, wherein the cycloalkyl rings are cyclohexyl rings.
Clause 27. The polymer of any Clauses 20 to 26, wherein each of R²¹, R²², and R²³ is hydrogen.
Clause 28. The polymer of any Clauses 20 to 27, wherein a ratio of x to z is about 0.1:1 to about 1:0.1.
Clause 29. The polymer of any Clauses 20 to 28, wherein the ratio of x to z is about 1:1 to about 3:1.
Clause 30. A metal substrate comprising the polymer of any Clauses 18 to 29 disposed thereon.
Clause 31. The polymer of Clause 25, wherein the cycloalkyl ketone is cyclohexanone or acetophenone.
Clause 32. The polymer of any Clauses 25 and 31, wherein the ketone is a limonene-derived ketone or a terpene-derived ketone.
Clause 33. The polymer of any Clauses 25 and 31 to 32, wherein the ketone is a limonene-derived ketone that is camphor.
Clause 34. The polymer of any Clauses 25 and 31 to 33, wherein the ketone is a terpene-derived ketone selected from the group consisting of terpenone, leucosesterterpenone, farnesyl acetone, leucosesterlactone, pseudoionone, and muqubilone.
Clause 35. The polymer of any Clauses 18 to 34, wherein R¹² is

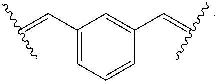 [SMILES: *=Cc1cccc(C=*)c1]

Clause 36. The method of forming the polymer of any Clauses 18 to 36, comprising
   forming a Schiff base by introducing either a diketone or dialdehyde to one or more thiosemicarbazides;
   introducing the Schiff base to one or more compositions comprising formaldehyde or formaldehyde and a ketone containing monomer; and
   introducing the polymer to an excess of thiosemicarbazide to produce a modified polymer having pendent Schiff base moieties.
Clause 37. A polymer represented by Formula (VII):

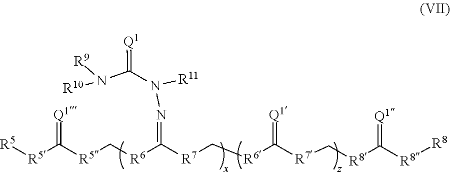

wherein:
each of R⁵ and R⁸ is independently hydrogen or —CH₂OH;
each of R⁶, R⁷, R^{6′}, R^{7′}, R^{5′}, R^{5″}, R^{8′}, and R^{8″} is independently a bond, aryl, alkyl, cycloalkyl, or heteroaryl, wherein R⁶ and R⁷, R^{6′} and R^{7′}, R^{5′} and R^{5″}, and R^{8′} and R^{8″} independently may combine to form a cycloalkyl ring or an aryl ring;
each of Q^{1″} and Q^{1′″} is independently oxygen, sulfur, or

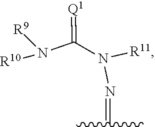

each of R⁹, R¹⁰, and R¹¹ is independently hydrogen, amino, aryl, alkyl, cycloalkyl, or heteroaryl;
each of Q¹ and Q^{1′} is independently oxygen or sulfur;
x is a positive integer, z is 0 or a positive integer, x+z is such that the polymer represented by Formula (VII) has a molecular weight of about 200 Daltons to about 2,000 Daltons, and the polymer represented by Formula (VII) is a block copolymer or a random copolymer.
Clause 38. The polymer of Clause 37, wherein each of R⁶, R^{6′}, R^{5′}, and R^{8′} is phenyl, each of R⁷, R^{7′}, and R^{5″} is methylene, and R^{8″} is methyl or methylene substituted with—CH₂OH.
Clause 39. The polymer of Clauses 37 or 38, wherein each of Q¹ and Q^{1′} is oxygen and each of R⁹, R¹⁰, and R¹¹ is hydrogen.
Clause 40. The polymer of any of Clauses 37 to 39, wherein each R⁶ and R⁷, R^{6′} and R^{7′}, R^{5′} and R^{5″}, and R^{8′} and R^{8″} independently may combine to form a cycloalkyl ring, such as a cyclohexyl ring.
Clause 41. The polymer of any of Clauses 37 to 40, wherein the cycloalkyl ring is a cyclohexyl ring.
Clause 42. The polymer of any of Clauses 37 to 41, wherein a ratio of x to z is about 0.1:1 to about 1:0.1.
Clause 43. The polymer of any of Clauses 37 to 42, wherein the ratio of x to z is about 1:1 to about 3:1.
Clause 44. The polymer of any of Clauses 37 to 43, wherein x is about 10 to about 15 and z is about 10 to about 15.
Clause 45. A metal substrate comprising the polymer of any of Clauses 37 to 44 disposed thereon.
Clause 46. A method of forming the polymer of any of Clauses 37 to 45, comprising introducing formaldehyde with a ketone to form an intermediate polymer followed by treating the intermediate polymer with a carbazide/semicarbazide represented by the formula:

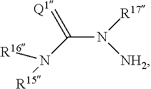

wherein Q^{1″} is oxygen or sulfur, and each of R^{15′}, R^{16′} and R^{17′} is independently hydrogen, amino, aryl, alkyl, cycloalkyl, or heteroaryl.
Clause 47. The method of any of Clauses 37 to 46, wherein the ketone is a cycloalkyl ketone.
Clause 48. The method of any of Clauses 37 to 47, wherein the cycloalkyl ketone is cyclohexanone or acetophenone.
Clause 49. The method of any of Clauses 37 to 48, wherein the ketone is a limonene-derived ketone or a terpene-derived ketone.
Clause 50. The method of any of Clauses 37 to 49, wherein the ketone is a limonene-derived ketone that is camphor.
Clause 51. The method of any of Clauses 37 to 50, wherein the ketone is a terpene-derived ketone selected from the group consisting of terpenone, leucosesterterpenone, farnesyl acetone, leucosesterlactone, pseudoionone, and muqubilone.
Clause 52. A polymer represented by Formula (XXV):

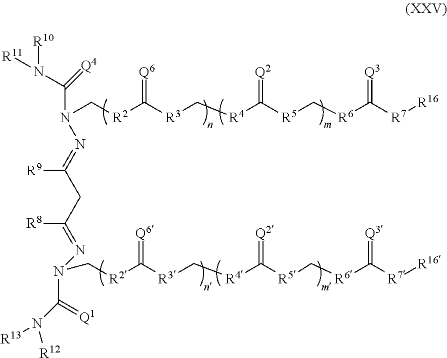

wherein:
R¹ is aryl, alkyl, cycloalkyl, or heteroaryl;
each R¹⁰ and R¹² is independently hydrogen, alkyl, cycloalkyl, aryl, or heteroaryl;
each of R⁸ and R⁹ is independently hydrogen, alkyl, cycloalkyl, aryl, or heteroaryl;
each of R¹¹ and R¹³ is independently hydrogen or represented by the formula:

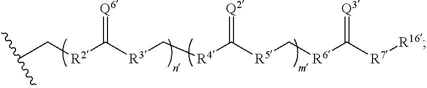

each instance of R², R³, R⁴, R⁵, R⁶, R⁷, R^{2′}, R^{3′}, R^{4′}, R^{5′}, R^{6′}, R^{7′} is independently aryl, alkyl, cycloalkyl, or heteroaryl, wherein R² and R³, R⁴ and R⁵, R⁶ and R⁷, R^{2′} and R^{3′}, R^{4′} and R^{5′}, and R^{6′} and R^{7′} independently may combine to form a cycloalkyl ring or an aryl ring;
each instance of R¹⁶ and R^{16′} is independently hydrogen or —CH₂OH;
each instance of Q¹, Q², Q^{2′}, and Q⁴ is independently oxygen or sulfur;
each instance of Q³, Q^{3′}, Q⁶, and Q^{6′} is independently oxygen, sulfur, or

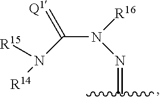

wherein each instance of Q^{1′} is independently oxygen or sulfur, and each instance of R¹⁴, R¹⁵ and R¹⁶ is independently hydrogen, aryl, alkyl, cycloalkyl, or heteroaryl,
each instance of n and n′ is independently a positive integer;
each instance of m and m′ is independently 0 or a positive integer, and the polymer represented by Formula (XXV) is a block copolymer or a random copolymer.
Clause 53. The polymer of Clause 52, wherein R¹ is aryl.
Clause 54. The polymer of Clauses 52 or 53, wherein R¹ is

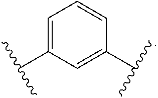 [SMILES: *c1cccc(*)c1]

Clause 55. The polymer of any of Clauses 52 to 54, wherein each instance of Q¹, Q², Q^{2′}, Q⁴, Q³, Q^{3′}, Q⁶, and Q^{6′} is oxygen.
Clause 56. The polymer of any of any of Clauses 52 to 55, wherein each instance of Q¹, Q², Q², and Q⁴ is oxygen and each instance of Q⁶, and Q^{6′} is independently

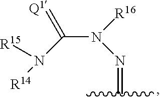

wherein each instance of Q^{1′} is oxygen, and each instance of R¹⁴, R¹⁵ and R¹⁶ is hydrogen.
Clause 57. The polymer of any of Clauses 52 to 56, wherein a ratio of n to m is about 0.1:1 to about 1:0.1.
Clause 58. The polymer of any of Clauses 52 to 57, wherein the ratio of n to m is about 1:1 to about 3:1.
Clause 59. The polymer of any of any of Clauses 52 to 58, wherein each instance of R² and R³, R⁴ and R⁵, R⁶ and R⁷, R^{2′} and R^{3′}, R^{4′} and R^{5′}, and R^{6′} and R^{7′} independently combine to form an alkyl ring.
Clause 60. The polymer of any of Clauses 52 to 59, wherein each instance of the alkyl ring is a cyclohexyl ring.
Clause 61. A metal substrate comprising the polymer of any of Clauses 52 to 60 disposed thereon.
Clause 62. A method of forming the polymer of any of Clauses 52 to 61, comprising forming an intermediate polymer by introducing formaldehyde and a ketone with a first semicarbazide represented by the formula:

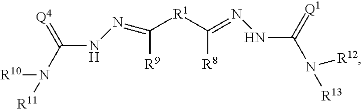

wherein each of Q¹ and Q⁴ is independently oxygen or sulfur, R¹ is aryl, alkyl, cycloalkyl, or heteroaryl; each of R⁸ and R⁹ is independently hydrogen, alkyl, cycloalkyl, aryl, or heteroaryl; and each of R¹⁰, R¹¹, R¹², and R¹³ is independently hydrogen, aryl, alkyl, cycloalkyl, or heteroaryl.
Clause 63. The method of any of Clauses 52 to 62, further comprising introducing the intermediate polymer with a second semicarbazide represented by the formula:

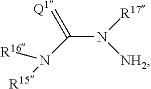

wherein Q^{1″} is oxygen or sulfur, and each of R^{15′}, R^{16′} and R¹⁷ is independently hydrogen, aryl, alkyl, cycloalkyl, or heteroaryl.
Clause 64. The method of any of Clauses 52 to 63, wherein R¹ is aryl.
Clause 65. The method of any of Clauses 52 to 64, wherein R¹ is

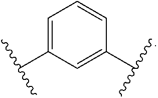 [SMILES: *c1cccc(*)c1]

Clause 66. The method of any of Clauses 52 to 65, wherein the ketone is a cyclic alkyl ketone.
Clause 67. The method of any of Clauses 52 to 66, wherein the cyclic alkyl ketone is cyclohexanone or acetophenone.
Clause 68. The method of any of Clauses 52 to 67, wherein the ketone is a limonene-derived ketone or a terpene-derived ketone.
Clause 69. The method of any of Clauses 52 to 68, wherein the ketone is a terpene-derived ketone selected from the group consisting of terpenone, leucosesterterpenone, farnesyl acetone, leucosesterlactone, pseudoionone, and muqubilone.

As used herein, a wavy line of a chemical structure indicates a connection point between the moiety shown to the rest of the molecule.

The term “composition” as used herein can include the components (e.g., an oligomer and metal and/or metal salt) and/or reaction product(s) of two or more components of the composition.

The term “catalytic amount” as used herein is the amount of a catalyst and/or composition to catalyze a reaction of one or more components of a reaction mixture.

The term “post-polymerization modification” as used herein is a process wherein a previously formed polymer having one or more reactive functional moieties dispersed along the polymer chain is added to a composition and is reacted with one or more structurally distinct molecules to structurally modify the previously formed polymer.

Unless otherwise stated/claimed, groups/moieties of Schiff base polymers described in the present disclosure are unsubstituted or substituted. The term “substituted” means that a group is substituted at any available position. Substitution can be with one or more groups selected from, e.g., alkyl, alkenyl, alkynyl, cycloalkyl, cycloalkenyl, aryl, heterocyclyl, heteroaryl, formyl, alkanoyl, cycloalkanoyl, aroyl, heteroaroyl, carboxyl, alkoxycarbonyl, cycloalkyloxycarbonyl, aryloxycarbonyl, heterocyclyloxycarbonyl, heteroaryloxycarbonyl, alkylaminocarbonyl, cycloalkylaminocarbonyl, arylaminocarbonyl, heterocyclylaminocarbonyl, heteroarylaminocarbonyl, cyano, alkoxy, cycloalkoxy, aryloxy, heterocyclyloxy, heteroaryloxy, alkanoate, cycloalkanoate, aryloate, heterocyclyloate, heteroaryloate, alkylcarbonylamino, cycloalkylcarbonylamino, arylcarbonylamino, heterocyclylcarbonylamino, heteroarylcarbonylamino, nitro, hydroxyl, halo (—F, —Cl, —Br, —I), haloalkyl, haloaryl, haloheterocyclyl, haloheteroaryl, haloalkoxy, silylalkyl, alkenylsilylalkyl, alkynylsilylalkyl, or amino. In some aspects, a substitution may be halo, alkyl, formyl, or amino. The optional substituents may include salts of the groups, for example carboxylate salts. It will be appreciated that “substituted” may include other groups not specifically described.

“Alkyl” whether used alone, or in compound words such as alkoxy, alkylthio, alkylamino, dialkylamino or haloalkyl, represents straight or branched chain hydrocarbons ranging in size from one to about 10 carbon atoms, or more. Thus alkyl moieties include, unless explicitly limited to smaller groups, moieties ranging in size, for example, from one to about 6 carbon atoms or greater, such as, methyl, ethyl, n-propyl, iso-propyl, butyl, pentyl, hexyl, and higher isomers, including, e.g., those straight or branched chain hydrocarbons ranging in size from about 6 to about 10 carbon atoms, or greater.

“Cycloalkyl” represents a mono- or polycarbocyclic ring system of varying sizes, e.g., from about 3 to about 10 carbon atoms, e.g., cyclopropyl, cyclobutyl, cyclopentyl, cyclohexyl or cycloheptyl. The term cycloalkyloxy represents the same groups linked through an oxygen atom such as cyclopentyloxy and cyclohexyloxy. The term cycloalkylthio represents the same groups linked through a sulfur atom such as cyclopentylthio and cyclohexylthio.

As will be understood, an aromatic group means a cyclic group having 4 m+2 π electrons, where m is an integer equal to or greater than 1. As used herein, “aromatic” is used interchangeably with “aryl” to refer to an aromatic group, regardless of the valency of aromatic group. Thus, aryl refers to monovalent aromatic groups, bivalent aromatic groups and higher multivalency aromatic groups.

“Aryl” includes aryl groups used alone or in compound words such as arylalkyl, aryloxy or arylthio. When used alone, aryl represents: (i) an optionally substituted mono- or polycyclic aromatic carbocyclic moiety, e.g., of about 6 to about 60 carbon atoms, such as phenyl, naphthyl or fluorenyl; or, (ii) an optionally substituted partially saturated polycyclic carbocyclic aromatic ring system in which an aryl and a cycloalkyl or cycloalkenyl group are fused together to form a cyclic structure such as a tetrahydronaphthyl, indenyl, indanyl or fluorene ring.

“Heterocyclyl” or “heterocyclic” whether used alone, or in compound words such as heterocyclyloxy represents: (i) an optionally substituted cycloalkyl or cycloalkenyl group, e.g., of about 3 to about 60 ring members, which may contain one or more heteroatoms such as nitrogen, oxygen, or sulfur (examples include pyrrolidinyl, morpholino, thiomorpholino, or fully or partially hydrogenated thienyl, furyl, pyrrolyl, thiazolyl, oxazolyl, oxazinyl, thiazinyl, pyridyl and azepinyl); (ii) an optionally substituted partially saturated polycyclic ring system in which an aryl (or heteroaryl) ring and a heterocyclic group are fused together to form a cyclic structure (examples include chromanyl, dihydrobenzofuryl and indolinyl); or (iii) an optionally substituted fully or partially saturated polycyclic fused ring system that has one or more bridges (examples include quinuclidinyl and dihydro-1,4-epoxynaphthyl).

A heteroaromatic group is an aromatic group or ring containing one or more heteroatoms, such as N, O, S, Se, Si or P. As used herein, “heteroaromatic” is used interchangeably with “heteroaryl”, and a heteroaryl group refers to monovalent aromatic groups, bivalent aromatic groups and higher multivalency aromatic groups containing one or more heteroatoms. “Heteroaryl” is considered one non-limiting type of “heterocyclyl”.

“Heteroaryl”, whether used alone, or in compound words such as heteroaryloxy represents: (i) an optionally substituted mono- or polycyclic aromatic organic moiety, e.g., of about 1 to about 10 ring members in which one or more of the ring members is/are element(s) other than carbon, for example nitrogen, oxygen, sulfur or silicon; the heteroatom(s) interrupting a carbocyclic ring structure and having a sufficient number of delocalized pi electrons to provide aromatic character, provided that the rings do not contain adjacent oxygen and/or sulfur atoms. Typical 6-membered heteroaryl groups are pyrazinyl, pyridazinyl, pyrazolyl, pyridyl and pyrimidinyl. All regioisomers are contemplated, e.g., 2-pyridyl, 3-pyridyl and 4-pyridyl. Typical 5-membered heteroaryl rings are furyl, imidazolyl, oxazolyl, isoxazolyl, isothiazolyl, oxadiazolyl, pyrrolyl, 1,3,4-thiadiazolyl, thiazolyl, thienyl, triazolyl, and silole. All regioisomers are contemplated, e.g., 2-thienyl and 3-thienyl. Bicyclic groups typically are benzo-fused ring systems derived from the heteroaryl groups named above, e.g., benzofuryl, benzimidazolyl, benzthiazolyl, indolyl, indolizinyl, isoquinolyl, quinazolinyl, quinolyl and benzothienyl; or, (ii) an optionally substituted partially saturated polycyclic heteroaryl ring system in which a heteroaryl and a cycloalkyl or cycloalkenyl group are fused together to form a cyclic structure such as a tetrahydroquinolyl or pyrindinyl ring.

“Hydroxyl” and “hydroxy” can be used interchangeably and represent a —OH moiety.

“Alkoxy” and “alkoxyl” can be used interchangeably and represent an —O-alkyl group in which the alkyl group is as defined supra. Examples include methoxy, ethoxy, n-propoxy, iso-propoxy, and the different butoxy, pentoxy, hexyloxy and higher isomers.

“Aryloxy” and “aryloxyl” can be used interchangeably and represent an —O-aryl group in which the aryl group is as defined supra. Examples include, without limitation, phenoxy and naphthoxy.

The compounds described herein may include salts, solvates, hydrates, isomers, tautomers, racemates, stereoisomers, enantiomers or diastereoisomers of those compounds. For example, salts may include sodium, potassium, calcium, nitrates, phosphates, sulfates, chlorides, or combinations thereof.

While the foregoing is directed to aspects of the present disclosure, other and further aspects of the disclosure may be devised without departing from the basic scope thereof, and the scope thereof is determined by the claims that follow.

1. A polymer represented by Formula (VII): 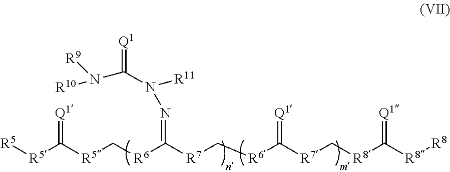
wherein:
each of R5 and R8 is independently hydrogen or —CH2OH;
each of R6, R7, R6′, R7′, R5′, R5″, R8′, and R8″ is independently a bond, aryl, alkyl, cycloalkyl, or heteroaryl, wherein R6 and R7, R6′ and R7′, R5′ and R5″, and R8′ and R8″ independently may combine to form a cycloalkyl ring or an aryl ring; 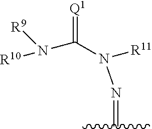
each of Q1″ and Q1′″ is independently oxygen, sulfur, or,
each of R9, R10, and R11 is independently hydrogen, amino, aryl, alkyl, cycloalkyl, or heteroaryl;
each of Q1 and Q1′ is independently oxygen or sulfur;
x is a positive integer, z is 0 or a positive integer, x+z is such that the polymer represented by Formula (VII) has a molecular weight of about 400 g/mol to about 20,000 g/mol, and the polymer represented by Formula (VII) is a block copolymer or a random copolymer.

2. The polymer of claim 1, wherein each of R6, R6′, R5′, and R8′ is phenyl, each of R7, R7′, and R5″ is methylene, and R8″ is methyl or methylene substituted with —CH2OH.

3. The polymer of claim 1, wherein each of Q1 and Q1′ is oxygen and each of R9, R10, and R11 is hydrogen.

4. The polymer of claim 1, wherein each R6 and R7, R6′ and R7′, R5′ and R5″, and R8′ and R8″ independently may combine to form a cycloalkyl ring, such as a cyclohexyl ring.

5. The polymer of claim 1, wherein the cycloalkyl ring is a cyclohexyl ring.

6. The polymer of claim 1, wherein a ratio of x to z is about 0.1:1 to about 1:0.1.

7. The polymer of claim 1, wherein the ratio of x to z is about 1:1 to about 3:1.

8. The polymer of claim 1, wherein x is about 10 to about 15 and z is about 10 to about 15.

9. A metal substrate comprising the polymer of claim 1 disposed thereon.

10. A method of forming the polymer of claim 1, comprising introducing formaldehyde with a ketone to form an intermediate polymer followed by treating the intermediate polymer with a carbazide/semicarbazide represented by the formula: 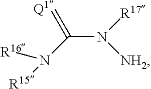
wherein Q1″ is oxygen or sulfur, and each of R15′, R16′ and R17′ is independently hydrogen, amino, aryl, alkyl, cycloalkyl, or heteroaryl.

11. The method of claim 10, wherein the ketone is a cycloalkyl ketone.

12. The method of claim 10, wherein the cycloalkyl ketone is cyclohexanone or acetophenone.

13. The method of claim 10, wherein the ketone is a limonene-derived ketone or a terpene-derived ketone.

14. The method of claim 10, wherein the ketone is a limonene-derived ketone that is camphor.

15. The method of claim 10, wherein the ketone is a terpene-derived ketone selected from the group consisting of terpenone, leucosesterterpenone, farnesyl acetone, leucosesterlactone, pseudoionone, and muqubilone.

16. A polymer represented by Formula (XXV): 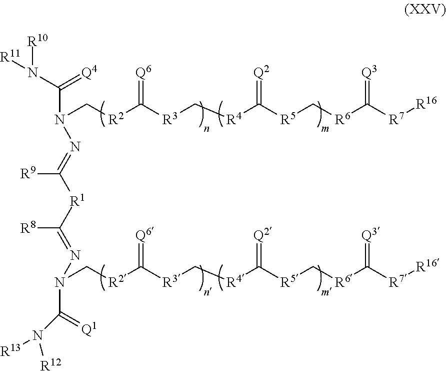
wherein:
R1 is aryl, alkyl, cycloalkyl, or heteroaryl;
each R10 and R12 is independently hydrogen, alkyl, cycloalkyl, aryl, or heteroaryl;
each of R8 and R9 is independently hydrogen, alkyl, cycloalkyl, aryl, or heteroaryl;
each of R11 and R13 is independently hydrogen or represented by the formula: 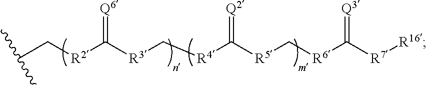
each instance of R2, R3, R4, R5, R6, R7, R2′, R3′, R4′, R5′, R6′, R7′ is independently aryl, alkyl, cycloalkyl, or heteroaryl, wherein R2 and R3, R4 and R5, R6 and R7, R2′ and R3′, R4′ and R5′, and R6′ and R7′ independently may combine to form a cycloalkyl ring or an aryl ring;
each instance of R16 and R16′ is independently hydrogen or —CH2OH;
each instance of Q1, Q2, Q2′, and Q4 is independently oxygen or sulfur; 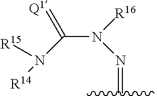
each instance of Q3, Q3′, Q6, and Q6′ is independently oxygen, sulfur, or, wherein each instance of Q1′ is independently oxygen or sulfur, and each instance of R14, R15 and R16 is independently hydrogen, aryl, alkyl, cycloalkyl, or heteroaryl,
each instance of n and n′ is independently a positive integer;
each instance of m and m′ is independently 0 or a positive integer, and
the polymer represented by Formula (XXV) is a block copolymer or a random copolymer.

17. The polymer of claim 16, wherein R1 is aryl.

18. The polymer of claim 16, wherein R1 is

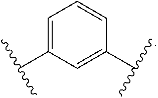 [SMILES: *c1cccc(*)c1]

19. The polymer of claim 16, wherein each instance of Q1, Q2, Q2′, Q4, Q3, Q3′, Q6, and Q6′ is oxygen.

20. The polymer of claim 16, wherein each instance of Q1, Q2, Q2′, and Q4 is oxygen and each instance of Q6, and Q6′ is independently 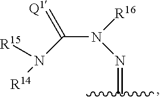
wherein each instance of Q1′ is oxygen, and each instance of R14, R15 and R16 is hydrogen.
